(19) United States
(12) Patent Application Publication
(10) Pub. No.: US 2005/0019052 A1
(43) Pub. Date: Jan. 27, 2005

(54) Power supply having two voltage outputs

(75) Inventor: Franciscus Gerardus Johannes Claassen, Oploo (NL)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/623,906

(22) Filed: Jul. 21, 2003

(51) Int. Cl. G03G 15/00

(52) U.S. Cl. 399/88

(57) ABSTRACT

A power supply useful in a printer or copier includes a main circuit for deriving a first predetermined voltage from a mains voltage, and a secondary circuit for deriving a second predetermined voltage from the same transformer which also generates the voltage for the first predetermined voltage. A preload circuit applies a preload current on the main circuit as a result of the secondary circuit going out of control, such as caused by a high load on the second terminal and a low load on the first terminal.

### TECHNICAL FIELD

The present disclosure relates to power supplies from which at least two voltage levels are available from different terminals. Such power supplies are useful in, for example, copiers and digital printers.

### BACKGROUND

A power supply which is useful in, for example, a mid- or high-volume digital printer or copier has two available voltage output terminals, such as one terminal making available 36V DC and another making available 24V DC, based on a single input of mains voltage available within the machine. In a possible xerographic printing context, one voltage is drawn for powering a laser or charging device within the machine, while the other is drawn for powering drive motors and other electromechanical parts.

In general, with multiple output power supplies, a primary output is controlled by a main feedback loop while a secondary output is stabilized by a secondary post regulation circuit. Especially when a magnetic amplifier (“magamp”) post control method is used, the post regulated output can go out of control in cases where the secondary output is under a heavy load while the primary output is under low load. Typically, in order to address this problem, various strategies have been employed: 1) using a higher turns ratio on the mains transformer, which would require higher-voltage-rated components; 2) using an extra step-down (buck) converter, which would require its own pulse width modulation, feedback and power switch circuits; or 3) using a second main converter circuit, with extra transformer power FETs, and an isolated feedback circuit, which is in effect providing two independent power supplies instead of one.

The present disclosure is directed to a multiple-output power supply which addresses these practical problems.

### PRIOR ART

U.S. Pat. No. 5,521,808 describes a circuit to drive and control a magamp coil to regulate the post controlled output in a two-output power supply. This circuit improves the magamp start-up behavior and prevents overshoot on the output. However, the reference does not teach a link to the main controlled output described, nor is there any discussion of preload or crossload problems between the two outputs.

### SUMMARY

According to one aspect, there is provided a power supply accepting a mains voltage as an input and outputting a first predetermined voltage from a first terminal and a second predetermined voltage from a second terminal. A main circuit derives the first predetermined voltage from the mains voltage and a secondary circuit derives the second predetermined voltage from the main circuit. A preload circuit applies a preload on the main circuit as a result of the secondary circuit going out of control.

According to another aspect, there is provided a printing apparatus comprising a first element and a second element, each element selected from a group comprising a charge generator, an imaging light source, a motor, a printhead, and a heat source. A power supply accepts a mains voltage as an input and outputs a first predetermined voltage from a first terminal and a second predetermined voltage from a second terminal, with the first element being associated with the first terminal and the second element being associated with the second terminal. A preload circuit in the power supply applies a preload on the main circuit as a result of the secondary circuit going out of control.

### BRIEF DESCRIPTION OF THE DRAWINGS

FIG. 1 is a simple diagram showing some basic elements of an electrostatographic printing apparatus, as would use a power supply.

FIG. 2 is a schematic diagram of a power supply.

### DETAILED DESCRIPTION

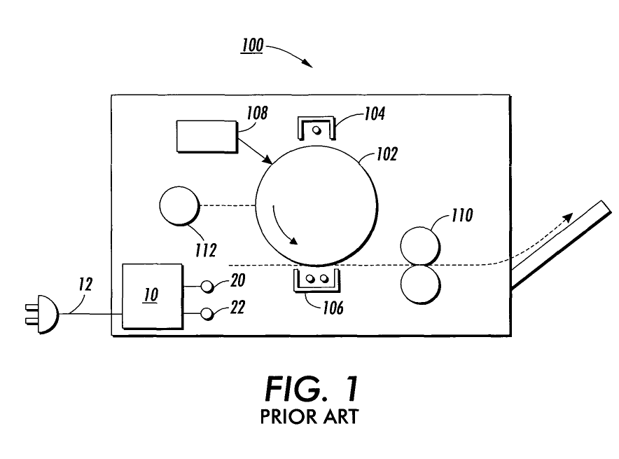

FIG. 1 is a simple diagram showing some basic elements of an electrostatographic printing apparatus generally indicated as 100, as would use a power supply such as generally indicated as 10. The printing apparatus 100 as shown is basically an electrostatographic or xerographic printer, but other types of printer, such as including an ink-jet printhead, can be contemplated as well. In a xerographic context, there is provided a number of typical elements, arranged around a photoreceptor 102, including one or more charge sources such as corotrons 104 or 106; an imaging light source such as laser 108 (but which could also be a lamp for use in a light-lens copier); a fuser 110 including one or more heating elements; as well as any number of motors such as 112. The power supply 10 must supply (through connections, not shown) to at least two of such elements different required voltage levels, for the apparatus 100 to operate properly. The power supply 10 derives its own power from a “mains voltage,” obtained through a plug 12.

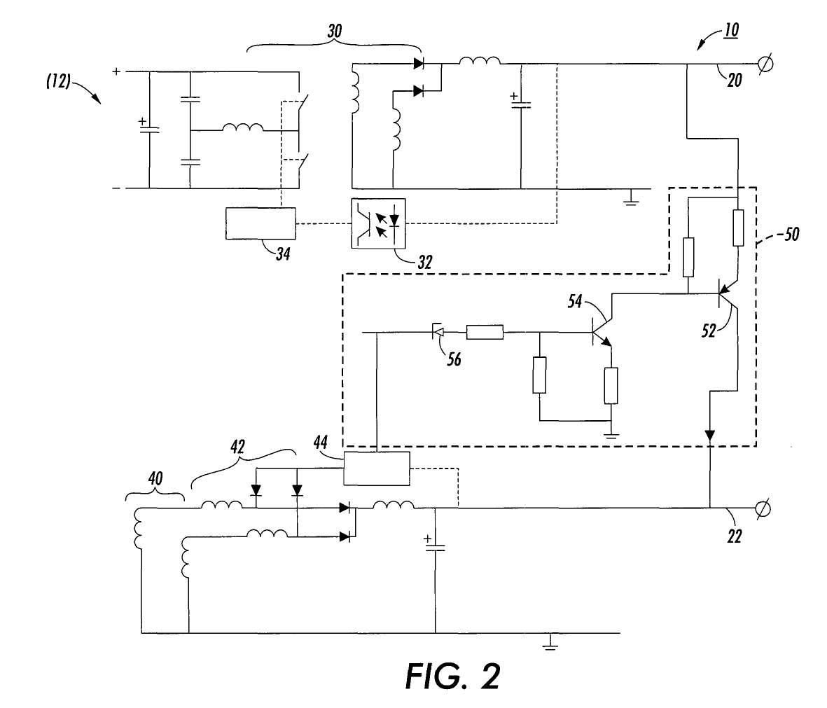

FIG. 2 is a schematic of a power supply 10, in this instance having a first output terminal 20, providing a first predetermined voltage, and a second output terminal 22, providing a second predetermined voltage, from which different elements can draw power as needed. The power supply accepts a “mains voltage,” which is derived ultimately through plug 12.

In this embodiment, the mains voltage from plug 12 is first converted to a first predetermined voltage, available at first output terminal 20, by a “main circuit,” here in the form of a pulse-width controlled switching transformer 30. The transformer 30 can be controlled with a feedback loop, such as including an optoelectronic device 32 leading to a pulse-width modulator controller 34, which in turn influences the switching duty cycle of the transformer 30.

A second predetermined voltage, available at second terminal 22, is derived, in this embodiment, from the main circuit through a second transformer winding 40. The conversion from the second transformer winding 40 to the second predetermined voltage is performed by a “secondary circuit” here including a post regulation circuit 42, controlled by a feedback circuit through a magamp controller 44, although other types of circuits can perform the equivalent function. (In the present embodiment, one transformer is in effect used to output both the first and second output voltages. The second transformer winding 40 is used to generate the second predetermined voltage, but the winding 40 is wound around the same core as the transformer 30 of the main circuit.)

A practical problem with multiple-output power supplies (in this instance, a two-output power supply) arises under conditions when the first terminal experiences a relatively low load and the second terminal experiences, simultaneously, a relatively high load. When the output voltage on the second terminal 22 drops for example due to an increase in load, it is typically compensated by the feedback circuit (in the embodiment, the magamp control circuit 44 and its associated elements) so that its output goes back to its original level. When the feedback circuit is not able to further compensate a voltage drop (or increase) on the output the feedback circuit, and thus the secondary circuit, is “out of control.” As the term is used herein, the secondary circuit is out of control when a further change of an error signal (such as associated with magamp controller 44) does not result in a change of the controlled power supply output, such as on terminal 22.

To address this problem, there is provided a “preload circuit” 50, here operatively interposed between the main circuit and the secondary circuit, in particular having an input from the magamp controller 44 governing secondary circuit 42, as well as a connection to terminal 22. The preload circuit 50 includes two transistors, 52 and 54, and a zener diode 56 interposed between the base of transistor 54 and an output from the magamp controller 44, as well as any number of resistors, generally shown, as would be desirable for a particular design.

In this embodiment the preload circuit 50 is a voltage-controlled current source to the secondary circuit. The overall function of preload circuit 50 is to apply a preload on the main circuit in case the secondary circuit goes out of control. This preload helps the secondary output in two ways: the extra preload on the first output terminal 20 increases the voltage on the secondary transformer winding 40, and the extra preload current of the first output terminal is fed into the second output terminal 22 and therefore not lost. In this way, a condition in which a low load is experienced by the main circuit while a high load is experienced by the secondary circuit does not result in an out of control situation for the secondary circuit. With the illustrated embodiment, there will be a range of load combinations, between the first output terminal 20 and the second output terminal 22, causing the preload circuit 50 could be activated.

Although the illustrated embodiment shows a circuit-based means for providing preload to the main circuit, other basic techniques, such as through direct measurement of the load on each terminal and application of the preload by an external digital control processor, may be contemplated as well.

1. A power supply accepting a mains voltage as an input and outputting a first predetermined voltage from a first terminal and a second predetermined voltage from a second terminal, comprising:
a main circuit for deriving the first predetermined voltage from the mains voltage;
a secondary circuit for deriving the second predetermined voltage from the main circuit; and
a preload circuit applying a preload on the main circuit as a result of the secondary circuit going out of control.

2. The power supply of claim 1, the main circuit including a transformer.

3. The power supply of claim 1, the preload circuit including an output directly to the second terminal.

4. The power supply of claim 1, the secondary circuit including a magamp controller.

5. The power supply of claim 4, the preload circuit including an output directly to the second terminal and an input from the magamp controller.

6. The power supply of claim 1, the secondary circuit including a post regulator circuit including a magamp controller.

7. The power supply of claim 1, the preload circuit including a voltage-controlled current source operatively interposed between the main circuit and the secondary circuit.

8. The power supply of claim 7, the voltage-controlled current source including a transistor having a base, the base of the transistor being associated with the magamp controller of the post regulated circuit.

9. The power supply of claim 8, further comprising a zener diode operatively disposed between the base of the transistor and the magamp controller of the post regulated circuit.

10. The power supply of claim 1, wherein the secondary circuit goes out of control as a result of a load on the first terminal being relatively low and a load on the second terminal being relatively high.

11. The power supply of claim 1, the main circuit including a transformer, and the secondary circuit deriving a second predetermined voltage from the transformer in the main circuit.

12. A method of operating a power supply, the power supply comprising a main circuit for deriving a first predetermined voltage from a mains voltage, and a secondary circuit for deriving a second predetermined voltage from the main circuit, comprising:
applying a preload on the main circuit as a result of the secondary circuit going out of control.

13. The method of claim 12, further comprising
providing a voltage-controlled current source operatively interposed between the main circuit and the secondary circuit.

14. The method of claim 12, wherein the secondary circuit goes out of control as a result of a load on the first terminal being relatively low and a load on the secondary terminal being relatively high.

15. The method of claim 12, wherein the main circuit includes a transformer, and the secondary circuit derives a second predetermined voltage from the transformer in the main circuit.

16. A printing apparatus comprising:
a first element, selected from a group comprising a charge generator, an imaging light source, a motor, a printhead, and a heat source;
a second element, selected from a group comprising a charge generator, an imaging light source, a motor, a printhead, and a heat source;
a power supply accepting a mains voltage as an input and outputting a first predetermined voltage from a first terminal and a second predetermined voltage from a second terminal;
the first element being associated with the first terminal and the second element being associated with the second terminal;
the power supply including
a main circuit for deriving the first predetermined voltage from the mains voltage,
a secondary circuit for deriving the second predetermined voltage from the main circuit, and
a preload circuit for applying a preload on the main circuit as a result of the secondary circuit going out of control.

17. The printing apparatus of claim 16, the secondary circuit in the power supply being a post regulator circuit.

18. The printing apparatus of claim 16, the preload circuit in the power supply including a voltage-controlled current source operatively interposed between the main circuit and the secondary circuit.

19. The printing apparatus of claim 16, wherein the secondary circuit goes out of control as a result of a load on the first terminal being relatively low and a load on the second terminal being relatively high.

20. The printing apparatus of claim 16, the main circuit in the power supply including a transformer, and the secondary circuit deriving a second predetermined voltage from the transformer in the main circuit.
